(19) United States
(12) Patent Application Publication
(10) Pub. No.: US 2004/0012219 A1
(43) Pub. Date: Jan. 22, 2004

(54) Multi-functional passenger compartment shield

(76) Inventor: Stanley Banks, Short Hills, NJ (US)

Correspondence Address: Barnes & Thornburg, 600 Summit Square, Fort Wayne, IN, 46802, US

(21) Appl. No.: 10/297,127

(22) PCT Filed: Dec. 28, 2001
(86) PCT No.: PCT/US01/50867

(51) Int. Cl. B62D 25/00

(52) U.S. Cl. 296/39.3

(57) ABSTRACT

A vehicle having a shield assembly for use with an exterior vehicle panel is provided. The shield assembly is a deformable substrate. The deformable substrate has a surface and a periphery. The surface of the deformable substrate forms to the exterior vehicle panel to absorb energy transmitted through the exterior vehicle panel.

### FIELD OF THE INVENTION

The present invention relates to the construction of vehicles and vehicle panels, and more particularly to a shield located adjacent exterior panels of a passenger compartment for dampening noise and blocking moisture.

### BACKGROUND AND SUMMARY

Generally, components surrounding and enclosing a passenger compartment of a vehicle comprise two major structures, an exterior panel and an interior panel. Conventionally, the exterior panel provides the structural strength to the compartment, as well as protection from the environment, whereas the interior panel is often designed for aesthetic purposes and access to various controls. Depending on the location of the compartment, such interior and exterior panels may sandwich other components, like window control mechanisms, door lock mechanisms, and controls for audio speakers, air conditioning and defrosting ducts, and other electrical and/or mechanical components, which are mounted in vehicle doors, for example. The particular combination may vary with a given manufacturer and model. Illustratively, such a vehicle door is described in U.S. Pat. No. 5,322,722 (Rozenberg), the disclosure of which is hereby incorporated herein by reference.

Though such panel assemblies include some insulation materials disposed there between, such materials often serve to dampen noise between attached panels caused by vibration of the vehicle during travel, rather than reducing the amount of noise generated outside the vehicle. The insulation is often located only between those strictures that might rattle. In addition, it is commonly known that water or dust can enter between the exterior and interior door panels, for example. Such contaminants, obviously, have the potential to adversely affect the operation of the various window and lock controls.

It would, therefore, be beneficial to provide a shield that can be located between exterior and interior panels that can dampen noise from the exterior panel of the passenger compartment. It would also be beneficial to provide a shield that can provide a moisture barrier to systems located between the panels. It would be further beneficial to provide a shield that can serve both functions, and still be economical and lighter than other barrier or insulation options.

Accordingly, an illustrative embodiment disclosed herein provides a vehicle having a door panel assembly. The door panel assembly comprises an exterior panel, an interior panel, a deformable substrate and a plurality of fasteners. The exterior panel has a surface area and a periphery with fastening receptacles located thereabout. The interior panel has a periphery with fastening receptacles located thereabout in coincidence with the fastening receptacles of the exterior panel. The deformable substrate has a surface area and a periphery, and is located between the exterior and interior panel. The deformable substrate also has fastening receptacles located thereabout in coincidence with the fastening receptacles of both the exterior and interior panels. The surface area of the deformable substrate abuts the surface area of the exterior panels. Each of the plurality of fasteners is disposed through fastening receptacles of the interior and exterior panels, as well as the deformable substrate.

Other illustrative embodiments may include a seal created between the surface areas of the exterior panel and the deformable substrate, and exterior and interior panels, as well as the deformable substrate have coinciding peripheries.

Another illustrative embodiment disclosed herein provides a shield for use with a vehicle door. The shield comprises a deformable substrate and is compressibly attachable to the vehicle door. Such an embodiment may further comprise the shield having a surface, the shield further comprising an adhesive distributed on the shield surface, a second adhesive being applied to the surface, the shield further comprising a peripheral portion, and an opening disposed the shield, the opening being in the peripheral portion and the opening being sized to receive a fastener therein, the body further comprising a passageway therethrough, the passageway being sized to receive a vehicular component therein, the adhesive being selected from a group comprising of a hot melt butyl or a hot melt rubber adhesive, the adhesive being pressure-sensitive, the shield comprising a material selected from a group comprising of plastics, rubbers, blends of plastics and rubber, polyethylene, ethyl vinyl acetate, polypropylene, polyvinyl chloride, or thermoplastic olefins.

Another illustrative embodiment disclosed herein provides a vehicle door panel assembly. The vehicle door panel assembly comprises an interior door trim panel, a shield, and a fastener. The shield comprises a deformable substrate. The fastener attaches the shield to the interior door trim panel. The panel assembly is attachable to a vehicle door.

Other illustrative embodiments may include the shield being able to form a seal with the vehicle door, the shield further comprising a compressible material, the seal comprising a compression fit, and the seal comprising an adhesive attachment.

Another illustrative embodiment disclosed herein provides a vehicle. The vehicle comprises a dash panel blanket for use with a dash panel of a passenger compartment of a vehicle. The dash panel blanket comprises a deformable cellular substrate. The deformable cellular substrate has a surface and a periphery. The surface of the deformable cellular substrate forms adjacent to the dash panel to absorb energy transmitted through the dash panel.

Another illustrative embodiment disclosed herein also provides a vehicle. The vehicle comprises a shield assembly for use with an exterior vehicle panel of a passenger compartment of a vehicle. The shield assembly comprises a single deformable cellular substrate. The deformable cellular substrate has a surface and a periphery. The surface of the deformable cellular substrate forms to the exterior vehicle panel to absorb energy transmitted through the exterior vehicle panel. Such an embodiment may further comprise the shield further having an adhesive distributed on the shield surface.

Another illustrative embodiment disclosed herein provides a vehicle having a passenger compartment. The passenger compartment comprises an exterior panel assembly. The exterior panel assembly comprises an exterior panel and an insulation blanket. The exterior panel is positioned on the passenger compartment and has a surface area. The insulation blanket comprises a deformable cellular substrate having a surface area. The surface is formed adjacent to the surface area of the exterior panel.

Other illustrative embodiments may include the insulation blanket being made from a polyethylene material, the exterior panel having a plurality of fasteners located about a periphery of the exterior panel wherein the insulation blanket is configured to receive the plurality of fasteners, the fasteners being configured to attach an interior panel located adjacent the insulation blanket opposite the exterior panel, the exterior panel being an exterior car door panel, the exterior panel being a car dash panel, and the insulation blanket being made from a material that has closure properties, and the insulation blanket comprises openings that are sealable by the closure properties of the material.

Additional features and illustrative embodiments of the invention will become apparent to those skilled in the art upon consideration of the following detailed description exemplifying the best mode of carrying out the invention as presently perceived.

### BRIEF DESCRIPTION OF THE DRAWINGS

The present invention will be described hereafter with reference to the attached drawings which are given as non-limiting examples only, in which:

FIG. 1 is a side elevation view of an illustrative exterior door panel;

FIG. 2 is a top plan view of one embodiment of a shield;

FIG. 3 is an exploded view of an interior door trim panel and the shield of FIG. 2;

FIG. 4 is a cross-sectional view of the shield of FIG. 2 taken along line 4-4;

FIG. 5 is an exploded view of a door assembly comprising the interior door trim panel of FIG. 3, a reverse view of the exterior door panel of FIG. 1, and the shield of FIG. 2;

FIG. 6 is an exploded perspective view of a dash panel with another embodiment of a shield;

FIG. 7 is a cross-sectional view of a portion of a passenger compartment showing the dash panel and shield of FIG. 6;

FIG. 8 is a cross-sectional view of a portion of a passenger compartment showing another embodiment of a shield; and

FIG. 9 is an exploded perspective view of a passenger compartment showing various interior and exterior panels, and illustrative embodiments of a shield located therebetween.

Corresponding reference characters indicate corresponding parts throughout the several figures. The exemplification set out herein illustrates general embodiments of the invention, and such exemplification is not to be construed as limiting the scope of the invention in any manner.

### DETAILED DESCRIPTION

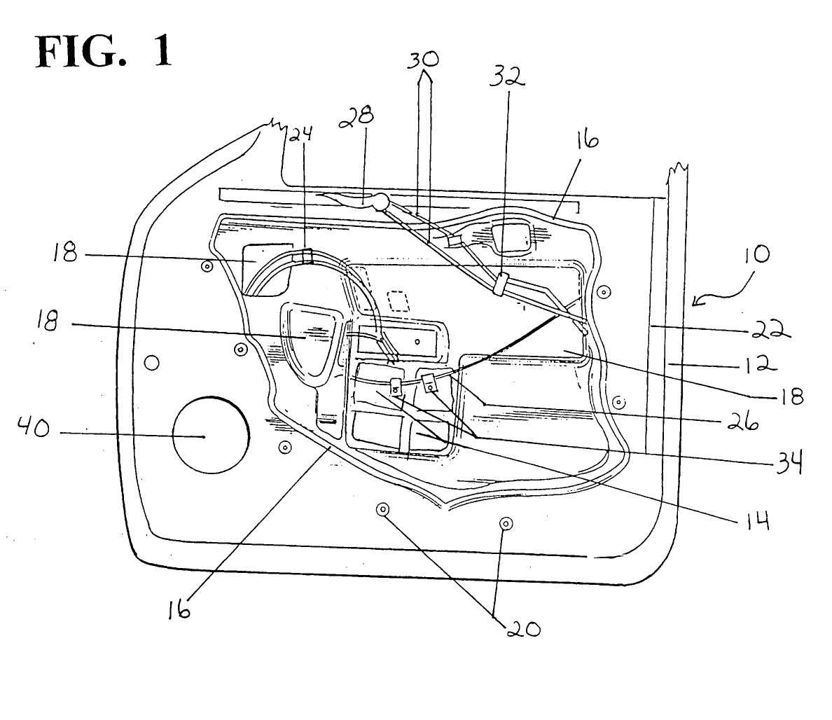

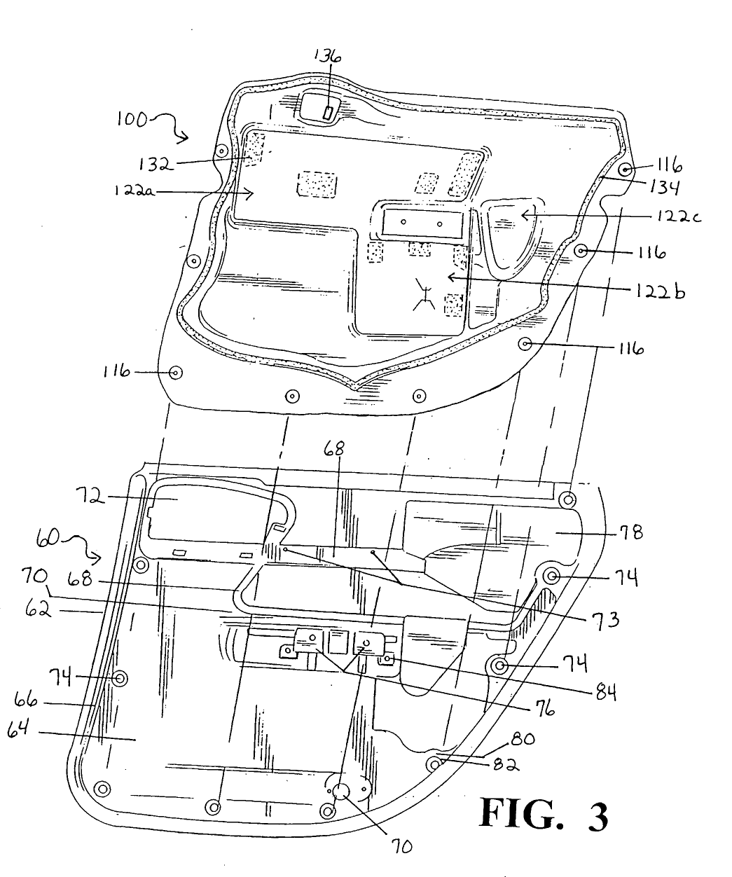

As an illustrative embodiment, FIGS. 1 through 5 show the vehicle door generally comprising two major elements, an exterior door panel 10 (FIG. 1), and an interior door trim panel 60 (FIG. 3), joined to each other to provide a chamber into which a window (not shown) can be raised and lowered. As shown in FIG. 1, exterior door panel 10 comprises a body 12 having a plurality of interior cavities 14 formed therein, the interior cavities being bounded by a wall 16. A plurality of receptacles 20 for receiving a plurality of fasteners 74 (FIG. 3) therein are distributed near the edges 22 of body 12. Also illustratively shown in FIG. 1 are controls and components that may be attached to or contained within the exterior door panel for use with opening and closing the door, and raising and lowering the window. Specifically shown as illustrative examples are first and second wiring harnesses 24 and 26, respectively, and a door handle 28 and its associated mechanism 30 needed for opening the door. Door mechanism 30 and wiring harnesses 24 and 26 are attached to the body 12 by fastener 32 and adhesive 34, respectively. Opening 40, a large circular opening in this example, which is outside of the area bounded by wall 16, is sized to receive an audio speaker (not shown). It is appreciated that other structures of an exterior door, known among those skilled in the art, can be inferred within the disclosure of said exterior door.

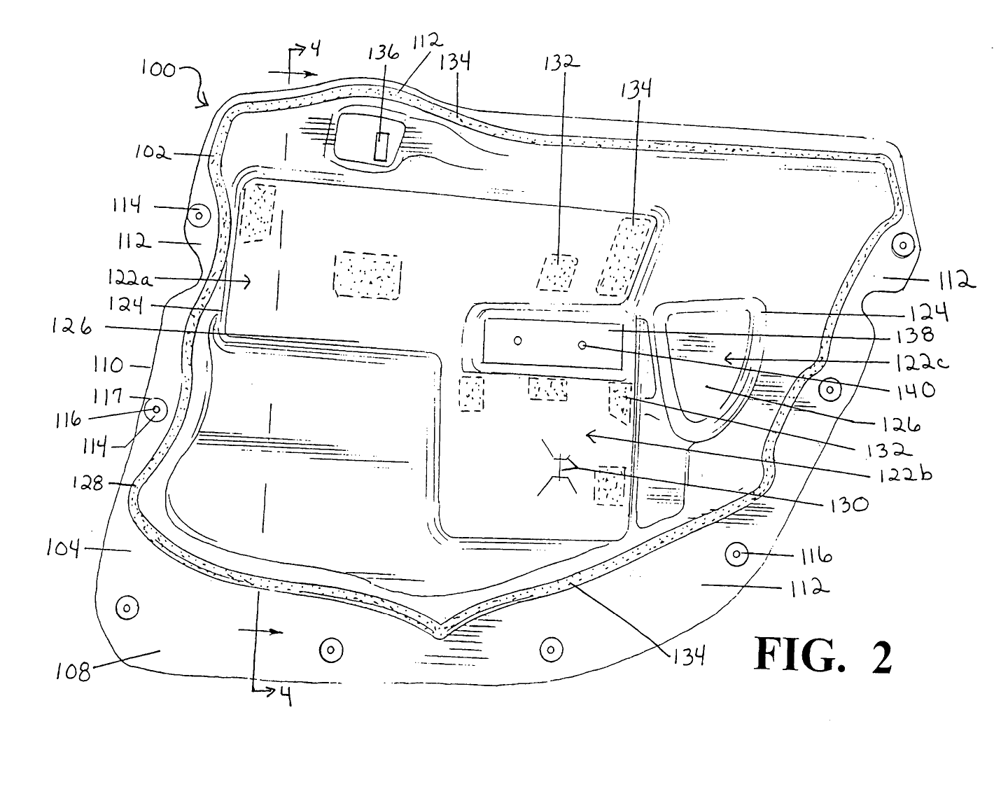

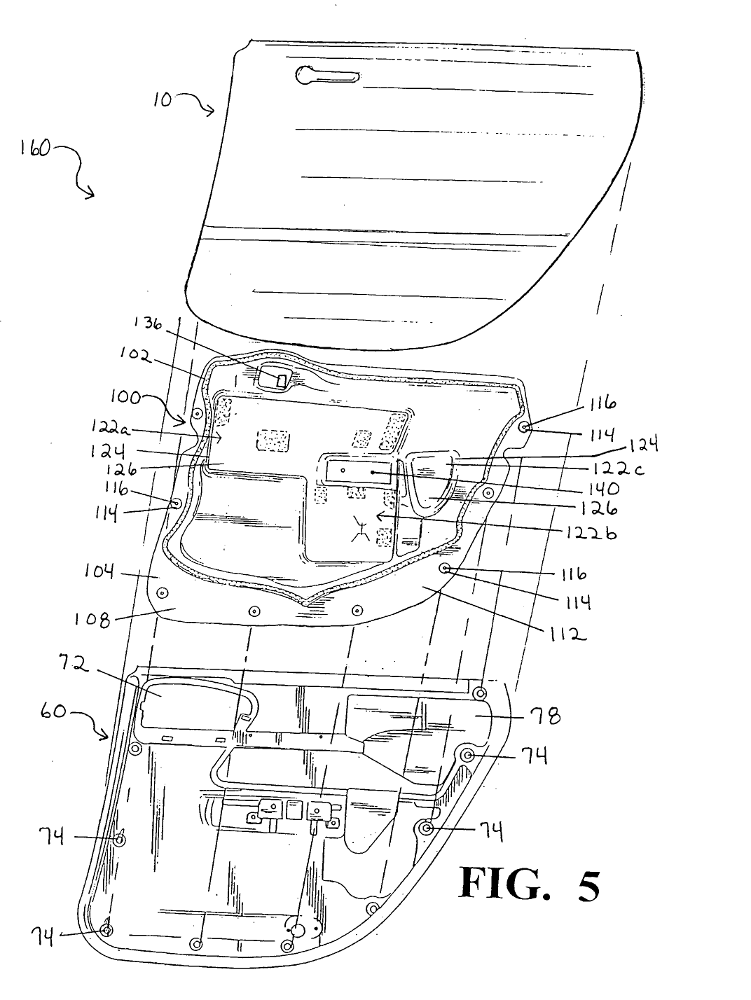

One illustrated embodiment of a shield 100 is shown in FIG. 2. This embodiment is for use as a shield between interior and exterior door panels 10 and 60. (See FIG. 5.) As will be discussed further herein, shield 100 is shown as an illustrative example only. It is appreciated that the configuration of the shield can be modified to fit the particular contours and shape of any vehicle door panel or even a compartment panel. Shield 100, as shown in FIG. 2, is formed to fit door panel 10, shown in FIG. 1. In this embodiment, shield 100 is positioned over the cavities 14 and door mechanism 30 to sealingly retain the vehicular components therein. It is further contemplated that shield 100 can be made in left-sided and right-sided configurations, as well as a configuration to suit a tailgate or hatchback door, rear doors of station wagons, vans, sport utility vehicles, and the like.

Illustratively, shield 100 includes a body 102 comprising a layer of plastic-like made from single component substrate base material. Body 102 can be manufactured using conventional processes of thermoforming, vacuum molding, or other processes known to those skilled in the art. In the illustrated embodiment, body 102 is a plastic, cross-linked, closed cell polyethylene foam material. It is contemplated, however, that other materials like plastics, rubbers, or blends of plastics and rubber, such as ethyl vinyl acetate (“EVA”), polypropylene (“PP”), polyvinyl chloride (“PVC”), or thermoplastic olefins (“TPOs”) may be used. Illustratively, the thickness of body 102 is approximately one-half inch. Thickness, however, can vary depending on the amount of dampening that is required by the particular surface shielded, as well as the space available between the interior and exterior panels.

It is appreciated that shield 100 is deformable or compressible, and is installed on the interior door trim panel 60 to which it remains attached, illustratively, by clips 74. The surface of shield 100 when in contact with the vehicular components can become deformed sufficiently to conform around the shape of the mechanism. This compressibility to assume different conformations around components enables the shield to effect better contact with the door panel components, and provide a tight seal against moisture, sound, and dirt infiltration, and is more economical for the manufacturer. In addition, such contact provides a barrier between parts that might otherwise squeak or rattle.

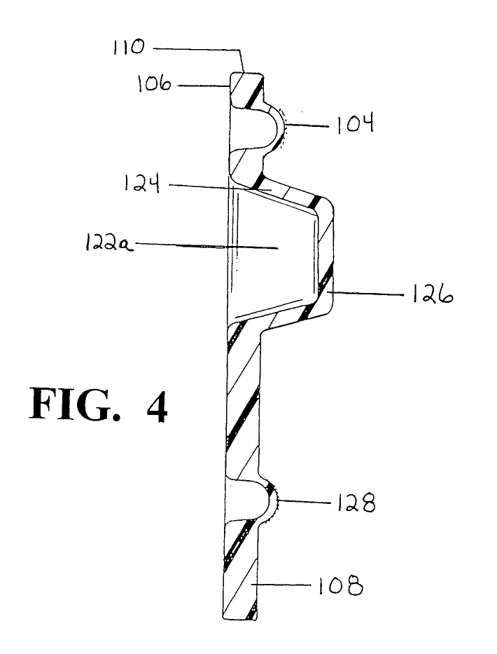

In the illustrated embodiment shown in FIGS. 2 and 4, body 102 comprises a top surface 104 and bottom surface 106. Each surface further comprises a peripheral portion 108 towards the outer edge 110 of the body 102. Peripheral portion 108 may include several curved regions 112 to enable the shield 100 to fit a particular panel. Body 102 further includes a number of pockets 122. The pockets 122 depend upwards from the plane of the top surface 104 (see FIG. 4), or depend downwards from the plane of the bottom surface 106 (not shown). Each pocket 122 comprises a wall 124 extending from the respective surface, the wall terminating in an end 126. Illustratively, wall 124 is continuous formed during the molding process and closed by end 126. The illustrated embodiment shown in FIG. 2 has three pockets 122a-c, wherein each pocket has a different shape, and each pocket 122 depends upwards from the plane of the body top surface 104.

Also shown in the illustrated shield 100 of FIG. 2 is a ridge 128 that extends along a portion of periphery 108 to facilitate the attachment of the shield 100 to the exterior door panel 10. Ridge 128 can further be described as an elongated pocket. In the illustrated embodiment, ridge 128 engages wall 16 to provide a waterproof seal between shield 100 and exterior door panel 10. Depending on the specifications of a given door panel, dimensions required for the pockets and depressed regions of a shield can be determined, taking into account factors such as the rigidity of the shield, its compressibility, and other manufacturing considerations known to those skilled in the art.

Along the peripheral region 108 are a number of depressions 114, and in each depression 114 an opening 116 is contained therein. In the illustrated embodiment, the depressions 114 are formed on both the shield top surface 104 and shield bottom surface 106, and are separated from the remainder of body 102 by a lip 117, which serves as a seal around fastener 74 when the shield is attached to the door panel.

It is contemplated that body 102 may be formed of other material to achieve other functional characteristics, or needed to comply with government regulations. Illustratively, these materials may include rubber or other synthetic materials in order to achieve a certain range of flexibility or deformability, and resistance to compression (degree of rebound after compression). In one illustrative embodiment, the shield may be formulated such that it is unaffected by cold temperatures as low as minus 30 degrees F., for example. Because this embodiment is unaffected by such cold temperatures, the shield minimizes squeaks, rattles, and itch sounds from the vehicle in which it is installed, as well as helps provide thermal insulation between the outside of the vehicle and the inside of the vehicle.

Openings 116 on shield 100 allow for passage of fasteners 74 which will attach the shield 100 to the interior door trim panel 60, and the exterior door 10. (See FIG. 5.) Shield 100 also includes a pocket 122b having a number of slits 130 disposed therethrough. (See FIG. 2). The pockets 122 may be complementary to surfaces within the exterior door panel 10; or the pockets 122 may include contact points 132, regions on the pocket end 126 and/or a combination of the pocket end 126 and pocket wall 124 which will form contacts with elements of the exterior door panel, and attach shield 100 to exterior door panel 10. Those contact points may also have adhesive to prevent squeaks and rattles between panels.

It is contemplated that the regions surrounding the slits 130 separate sufficiently to allow for the passage of vehicular components, such as, for example, a wiring harness 24 through the bottom and wall of the pocket, and for the component to be sealingly retained therein. Slits 130 can also be cut into other portions of shield 100 as dictated by manufacturing requirements.

A passageway 136 is illustratively formed in shield 100 which allows for the passage of a vehicular component, in this case, a door handle 28, to fit through the shield and to be sealingly retained therein. It is contemplated that additional passageways can be added as needed. Region 138 formed within the shield includes apertures 140 through which a fastener, such as a screw (not shown), is inserted for attachment of other vehicular components, such as an arm rest (not shown), to the door panel during final assembly.

An adhesive 134 is applied to the top surface 104 of the shield 100. This adhesive 134 is illustratively applied as a bead around the top surface 104 on the peripheral portion 108 and ridge 128. The adhesive 134 can be selected from any one of the conventionally known adhesives used in the art, including, but not limited to, adhesives such as neoprene, various types of rubber lattices, hot melt butyl adhesives, or hot melt rubber adhesives. In one illustrative embodiment, adhesive 134 can be a hot melt butyl adhesive that is waterproof. Adhesive 134 may also be covered with a protective, removable strip of a release paper, known to those skilled in the art, to protect it during shipping.

It is appreciated that adhesive 134 may also be applied to other parts of the top surface 104 where needed. For example, in the illustrated embodiment, adhesive 134 is applied to the contact points 132. (See FIG. 2). It is farther appreciated that the number of contact points and their locations will vary based upon manufacturing specifications. For example, adhesive 134 applied to the contact point 132 can be a flat, pressure sensitive adhesive manufactured from an acrylic base, known to those skilled in the art, while a waterproof adhesive is applied to the ridge and top surface for joining the shield 100 to exterior door panel 10.

The attachment of the shield to the exterior door panel at the contact points 132 also minimizes the transfer of sound into the vehicle. Specifically, because it is known that noise enters the passenger compartment of the vehicle through vibration or energy transferred through exterior panels, it is contemplated that the surface contact between the shield and the surface of the exterior panels causes the energy from the vibration of that exterior panel to be absorbed by the shield. Having surface area of the exterior door panels in contact with surface area of the shield causes that energy to be transferred and dissipated through the shield, rather than transfer into the passenger compartment in the form of noise. Furthermore, because the material is as aforementioned described, it is of lighter weight adding to the reduced cost and ease of manufacturing the vehicle.

An exploded view of the shield 100 and the interior door trim panel 60 is shown in FIG. 3. In the illustrated embodiment, interior door trim panel 60 comprises a body 62 with a top surface 64 which is formed according to the door's specifications. Towards the outer edge of body 62 is a ridge 66 that extends most of the way around the body's perimeter. Other raised areas 68 and depressed areas 70 are formed within body 62. Body 62 includes a plurality of cavities 72 formed therein, and a plurality of openings 73, of different shapes and sizes, are dispersed throughout body 62. A plurality of fasteners 74 are distributed within the body and, illustratively, are positioned near the body perimeter. Fasteners 74 are elongate clips that attach shield 100 to the interior door trim panel 60 to exterior panel 10, and sandwich the shield 100 therebetween. This allows the use of the same set of clips to attach the interior door trim panel 60 to both the shield 100 and the exterior door panel 10. (See FIG. 5.) The clips 74 are often referred to as “Christmas tree clips” because of their shape, as known to those skilled in the art. Also illustratively shown in FIG. 3 are controls and components that may be attached to or contained within the interior door trim panel, a control mechanism 76, and regions of insulating or sound deadening materials 78. Door handle 28 fits through one cavity 72 of interior door trim panel. (See also FIG. 1.) Each fastener 74 is attached in an elevated region 80 of the body, such that a lip 82 is formed; these function to form a tight seal when the interior door trim panel 60 is attached to the exterior door panel 10. Control mechanism 76 is attached to body 62 by a second fastener 84.

Illustratively, when the shield 100 is attached to the interior door trim panel 60, the assembler positions the bottom surface 106 of the shield facing the interior door trim panel 60, and inserts fasteners 74 through openings 116, thereby attaching the shield to the interior door trim panel to form a panel assembly 160. (See FIG. 5). After the shield 100 has been installed on the interior door trim panel 60, the raised areas 122 and pockets 124 of the shield correspond to the contours of the interior door trim panel and the components contained therein (FIGS. 1, 3 and 5).

Assembly of the vehicle door illustratively comprises removing the strips of release paper covering the adhesive from assembly 160, and aligning fasteners 74 with their corresponding receptacles 20 on exterior door panel 10. (See FIGS. 1 and 5.) In this manner, the adhesive forms a water tight seal, and the contact regions 132 attach the shield to portions of the exterior door panel, thus effecting a seal that is water proof, resistant to dust intrusion, minimizes sound transfer into the vehicle, and has thermal insulating properties. Such assembly 160 is shown in FIG. 5. The use of the assembly 160 can provide significantly reduced installation or assembly costs generally, as well as may eliminate some of the installation and assembly costs incurred specifically at the final assembly site. The assembly 160 containing the shield and the interior door trim and exterior door panels provides force sufficient to cause the adhesive to properly bond to the inner surface of the exterior door components, thereby forming a protective seal around those mechanisms which require protection from the elements.

In another illustrative embodiment, the shield may comprise multiple layers of materials. In one such embodiment, the base layer may be surrounded by two layers of material. The first and second layers can be identical materials, or be different materials. Such materials can include those materials known to those skilled in the art for sound proofing, vibration dampening, thermal insulation, or for the absorption of energy to dissipate the impact of a vehicular collision. Energy absorbing materials may be incorporated into the shield of the present invention when required to meet government impact absorption requirements specified for certain doors to provide additional protection for passengers. For purposes of example only, and not intending to be limited by them, examples of materials used for sound proofing include ground organic materials, such as mica, or plastics, such as ethyl vinyl acetate, polyethylene, polypropylene, or poly vinyl chloride. Examples of energy absorbing materials which may be used include synthetic gels, or honeycomb structures of various materials, such as those described in U.S. Pat. No. 5,595,415, the disclosure of which is hereby expressly incorporated by reference herein.

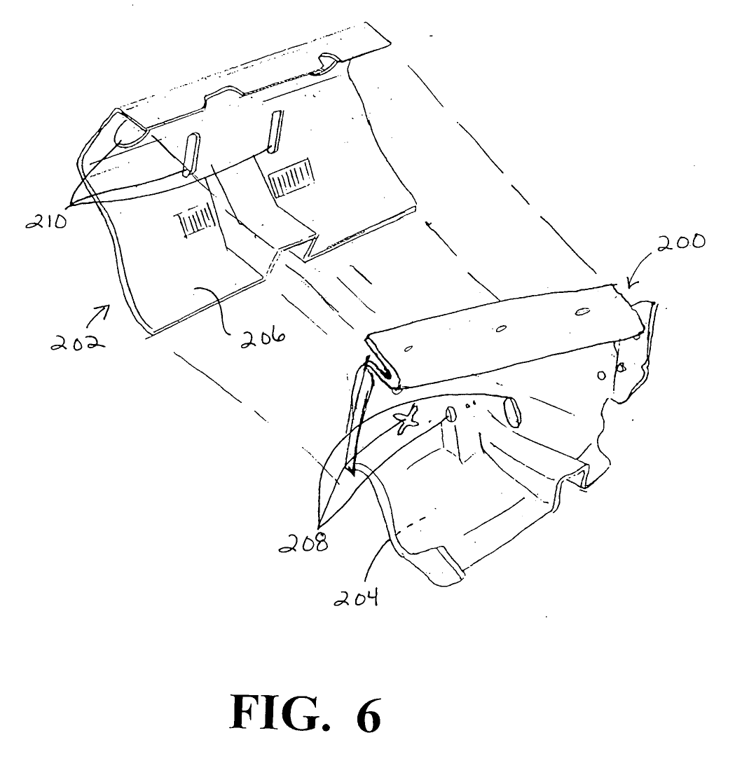

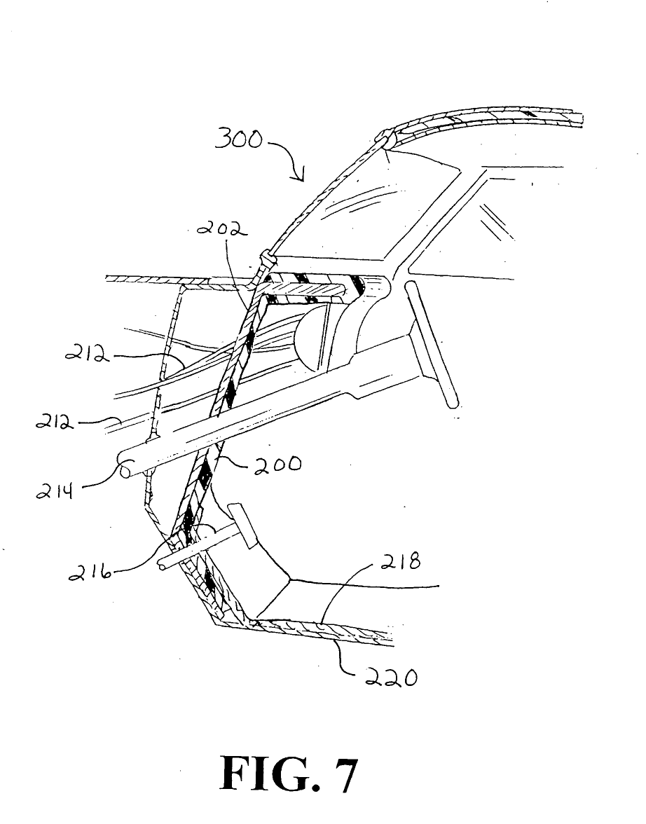

Another illustrative embodiment of a shield 200 is shown in FIGS. 6 and 7. An exploded perspective view of a dash panel 202 with another embodiment of shield 200 is shown in FIG. 6. It is contemplated that a substantial portion of surface 204 of shield 200 will shroud surface 206 of dash panel 202. In addition, various ports 208 disposed through shield 200 coincide with ports 210 disposed through dash panel 202 to allow for passage of ventilation equipment, control mechanisms, and the like to dispose through shield 200 as easily as they would through panel 202. It is further contemplated that the material of shield 202 will be that of the other embodiment of the shield 100 previously described herein. The use of such material as a shield 200 will serve to absorb the vibration that dash panel 202 experiences. Because so much of the shield 200 is in contact with panel 202, the energy in the form of sound wave can transfer from the panel 202 to shield 200 which serves to dissipate the energy or wave. The effect is less noise experienced by a passenger in the vehicle. It is appreciated that use of such material will also ease assembly and cost because of its lighter weight than the conventional plastic and foam insulation that is typically positioned adjacent panel 202. In addition, it is contemplated that shield 200, along with all other embodiments, can be configured with the requisite pass-throughs or other structures that are compatible with current or future fasteners for assembling the exterior and interior panels together.

A cross-sectional view of a portion of a passenger compartment 300 is shown in FIG. 7 with shield 200 located adjacent dash panel 202. This view demonstrates how shield 200 serves as a barrier between noise from the outside environment and the passenger compartment while still allowing passage of such components as wiring 212, a steering column 214, and a control pedal 216 through passenger compartment 300. Furthermore, the exposure of the shield to a passenger in compartment 300 can be obscured by the carpeting 218 shown covering a portion of shield 200, as well as the flooring 220, for example. It is appreciated that shield 200 can be made of any desired shape to shroud any such panel of any make or model of vehicle.

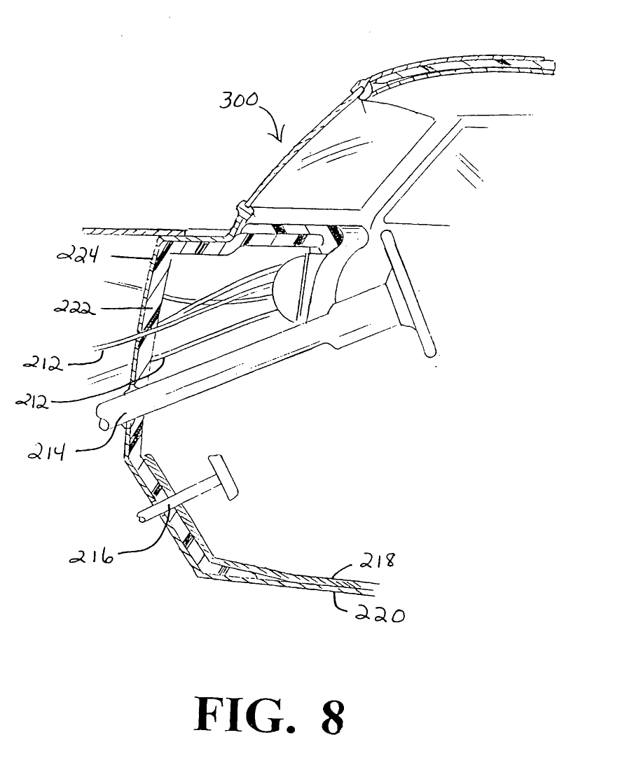

Another embodiment of a shield 222 is shown in FIG. 8. Shield 222 is similar to shield 200, except that it is located adjacent fire wall 224. It is contemplated that, again, similar to shield 200 and dash panel 202, shield 222 will shroud over and form adjacent the panel surface of fire wall 224, ensuring substantial surface area contact between shield 222 and fire wall 224 to dampen noise. It is also contemplated that shield 224 also comprises passages disposed therethrough to allow structures 212, 214, and 216 to extend therethrough, as previously discussed.

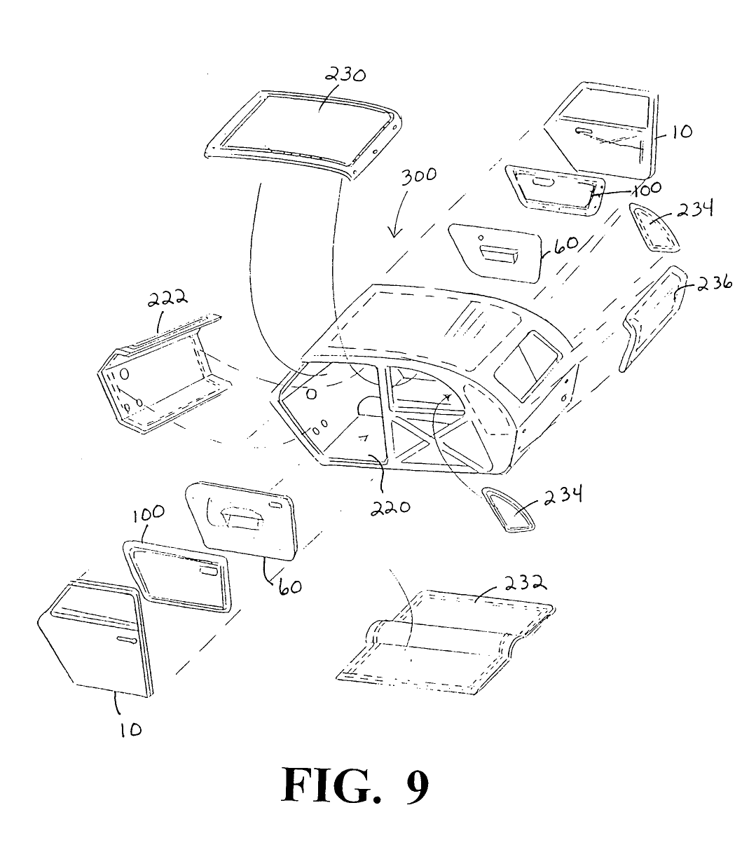

An exploded view of passenger compartment 300 is shown in FIG. 9, depicting various illustrative locations a shield can be located with respect to the compartment. For example, door shield 100 and fire wall shield 222 are shown, along with a roof shield 230, a floor shield 232, sail panel shields 234, and a rear panel shield 236. The common factor among all the various shields is that they be positioned to abut an exterior surface with a substantial amount of surface area of the shield being in contact with a corresponding amount of surface area of the exterior panel. It is contemplated that the shields will comprise similar material to that previously described for shields 100, 200, and 222.

Although this disclosure has been described with reference to particular means, materials and embodiments, from the foregoing description, one skilled in the art can easily ascertain the essential characteristics of the present invention and various changes and modifications may be made to adapt the various uses and characteristics without departing from the spirit and scope of the present invention as described by the claims which follow.

What is claimed is:

1. A vehicle having a door panel assembly, the door panel assembly comprising:
an exterior panel having a surface area and a periphery with fastening receptacles located thereabout;
an interior panel having a periphery with fastening receptacles located thereabout in coincidence with the fastening receptacles of the exterior panel;
a deformable substrate having a surface area and a periphery, and is located between the exterior and interior panel, and has fastening receptacles located thereabout in coincidence with the fastening receptacles of both the exterior and interior panels;
wherein the surface area of the deformable substrate abuts the surface area of the exterior panel; and
a plurality of fasteners, each disposed through fastening receptacles of the interior and exterior panels as well as the deformable substrate.

2. The door panel assembly of claim 1, wherein a seal is created between the surface areas of the exterior panel and the deformable substrate.

3. The door panel assembly of claim 1, wherein exterior and interior panels as well as the deformable substrate have coinciding peripheries.

4. For use with a vehicle door, a shield comprising a deformable substrate; said shield being compressibly attachable to the vehicle door.

5. A shield of claim 4, wherein:
the shield has a surface; and
the shield further comprises an adhesive distributed on the shield surface.

6. The shield of claim 5, wherein a second adhesive is applied to the surface.

7. The shield of claim 4, wherein the shield further comprises a peripheral portion.

8. The shield of claim 7, wherein the shield further comprises an opening therethrough, the opening being in the peripheral portion and the opening being sized to receive a fastener therein.

9. The shield of claim 8, wherein the body further comprises a passageway therethrough, the passageway being sized to receive a vehicular component therein.

10. The shield of claim 4, wherein the adhesive is selected from a group comprising of a hot melt butyl or a hot melt rubber adhesive.

11. The shield of claim 6, wherein the adhesive is pressure-sensitive.

12. The shield of claim 4, wherein the shield comprises a material selected from a group comprising of plastics, rubbers, blends of plastics and rubber, polyethylene, ethyl vinyl acetate, polypropylene, polyvinyl chloride, or thermoplastic olefins.

13. A vehicle door panel assembly comprising:
an interior door trim panel;
a shield comprising a deformable substrate; and
a fastener to attach the shield to the interior door trim panel;
wherein the panel assembly being attachable to a vehicle door.

14. The vehicle door panel assembly of claim 13, wherein the shield being able to form a seal with the vehicle door.

15. The vehicle door panel assembly of claim 14, wherein:
the shield further comprises a compressible material; and
the seal comprises a compression fit.

16. A panel assembly of claim 14, wherein the seal comprises an adhesive attachment.

17. A vehicle, the vehicle comprising a dash panel blanket for use with a dash panel of a passenger compartment of a vehicle, the dash panel blanket comprising:
a deformable cellular substrate having a surface and a periphery;
wherein the surface of the deformable cellular substrate forms adjacent to the dash panel to absorb energy transmitted through the dash panel.

18. A vehicle, the vehicle comprising a shield assembly for use with an exterior vehicle panel of a passenger compartment of a vehicle, the shield assembly comprising:
a single deformable cellular substrate having a surface and a periphery;
wherein the surface of the deformable cellular substrate forms to the exterior vehicle panel to absorb energy transmitted from through the exterior vehicle panel.

19. The shield assembly of claim 18, wherein the shield further comprises an adhesive distributed on the shield surface.

20. A vehicle having a passenger compartment comprising an exterior panel assembly, the exterior panel assembly comprises:
an exterior panel positioned on the passenger compartment, the exterior panel having a surface area; and
an insulation blanket;
wherein the insulation blanket comprises a deformable cellular substrate having a surface area; and
wherein the surface is formed adjacent to the surface area of the exterior panel.

21. The exterior panel assembly of claim 20, wherein the insulation blanket is made from a polyethylene material.

22. The exterior panel assembly of claim 20, wherein the exterior panel has a plurality of fasteners located about a periphery of the exterior panel, wherein the insulation blanket is configured to receive the plurality of fasteners.

23. The exterior panel assembly of claim 22, wherein the fasteners are configured to attach an interior panel located adjacent the insulation blanket opposite the exterior panel.

24. The exterior panel assembly of claim 20, wherein the exterior panel is an exterior car door panel.

25. The exterior panel assembly of claim 20, wherein the exterior panel is a car dash panel.

26. The exterior panel assembly of claim 20, wherein the insulation blanket is made from a material that has closure properties, and the insulation blanket comprises openings that are sealable by the closure properties of the material.
